(19) United States
(12) Patent Application Publication
(10) Pub. No.: US 2007/0277906 A1
(43) Pub. Date: Dec. 6, 2007

(54) Water-Based Metal Treatment Composition

(75) Inventors: Peter Gamon Johns, Hertfordshire (GB); Clare Elizabeth Harrison, London (GB)

Correspondence Address: KELLEY DRYE & WARREN LLP, 400 ALTLANTIC STREET , 13TH FLOOR, STAMFORD, CT, 06901, US

(73) Assignee: MIDDLESEX SILVER CO., LIMITED, LONDON (GB)

(21) Appl. No.: 10/594,477

(22) PCT Filed: Mar. 24, 2005
(86) PCT No.: PCT/GB05/50043

§ 371 Date: Jul. 2, 2007

(30) Foreign Application Priority Data
Mar. 30, 2004 (GB) 0407163.5

(51) Int. Cl. C23F 11/16; C09G 1/02; C11D 11/00; C11D 3/00; C11D 3/34

(52) U.S. Cl. 148/22

(57) ABSTRACT

Disclosed for use in treating a metal, e.g., an alloy of silver as aforesaid, is a water-based composition comprising a treatment agent selected from an alkanethiol, alkyl thioglycollate, dialkyl sulfide or dialkyl disulfide and at least one of an amphoteric, nonionic or cationic surfactant in a concentration that is effective to solubilise the treatment agent. Preferably the composition comprises at least a non-ionic relatively hydrophobic surfactant e.g. cocamide DEA. The composition is particularly suitable for the treatment of Ag—Cu—Ge alloys.

### FIELD OF THE INVENTION

The present invention relates to a water-based composition that can be used for the treatment of a metal which may be a silver alloy but which may also be another metal requiring surface treatment to impart tarnish resistance e.g. copper, brass or nickel.

### BACKGROUND TO THE INVENTION

Silver Alloys and Their Tarnish-Resistance

Standard Sterling silver provides manufacturers and silversmiths with a versatile and reliable material but it is inevitable that finished articles will require further cleaning and polishing to temporarily remove undesired tarnish products. It is well-known that with exposure to everyday atmospheric conditions, silver and silver alloys develop a lustre-destroying dark film known as tarnish.

Since ancient times it has been appreciated that unalloyed ‘fine’ silver is too soft to withstand normal usage, and it has been the practice to add a proportion of a base metal to increase hardness and strength. In the UK, legislation that has existed since the fourteenth century specifies a minimum silver content of articles for sale at 92.5% (the Sterling standard), but does not specify the base metal constituents. Experience convinced early silversmiths that copper was the most suitable of the metals available to them. Modern silver-sheet manufacturers generally adhere to this composition, although sometimes a proportion of copper is replaced by cadmium to attain even greater ductility. Sterling with a 2.5% cadmium content is a standard material for spinning and stamping. Lower grades of silver alloys are common in many parts of Europe for the production of hollow-ware and cutlery. The 800-grade alloys (Ag parts per thousand) are predominantly used in southern and mid-Europe whereas in Scandinavia the 830 standard is predominant.

In all but the largest manufacturing companies, most of the annealing and soldering required to assemble finished or semi-finished articles is carried out with the flame of an air-gas blowtorch. The oxidising or reducing nature of the flame and the temperature of the articles are controlled only by the skill of the silversmith. Pure silver allows oxygen to pass easily through it, particularly when the silver is heated to above red heat. Silver does not oxidise in air, but the copper in a silver/copper alloy is oxidised to cuprous or cupric oxide. Pickling of the oxidised surface of the article in hot dilute sulphuric acid removes the superficial but not the deeper-seated copper oxide so that the surface consists of fine or unalloyed silver covering a layer of silver/copper oxide mixture. The pure silver is easily permeated during further heating, allowing copper located deeper below the surface to become oxidised. Successive annealing, cold working and pickling produces a surface that exhibits the pure lustre of silver when lightly polished but with heavier polishing reveals dark and disfiguring stains known as ‘firestain’ or ‘fire’. Soldering operations are much more productive of deep firestain because of the higher temperatures involved. When the depth of the firestain exceeds about 0.025 mm (0.010 inches) the alloy is additionally prone to cracking and difficult to solder because an oxide surface is not wetted by solder so that a proper metallurgical bond is not formed.

Patent GB-B-2255348 (Rateau, Albert and Johns; Metaleurop Recherche) disclosed a novel silver alloy that maintained the properties of hardness and lustre inherent in Ag—Cu alloys while reducing problems resulting from the tendency of the copper content to oxidise. The alloys were ternary Ag—Cu—Ge alloys containing at least 92.5 wt % Ag, 0.5-3 wt % Ge and the balance, apart from impurities, copper. The alloys were stated to be stainless in ambient air during conventional production, transformation and finishing operations, to be easily deformable when cold, to be easily brazed and not to give rise to significant shrinkage on casting. They were also stated to exhibit superior ductility and tensile strength and to be annealable to a required hardness. Germanium was stated to exert a protective function that was responsible for the advantageous combination of properties exhibited by the new alloys, and was in solid solution in both the silver and the copper phases. The microstructure of the alloy was said to be constituted by two phases, a solid solution of germanium and copper in silver surrounded by a filamentous solid solution of germanium and silver and copper. The germanium in the copper-rich phase was said to inhibit surface oxidation of that phase by forming a thin GeO or GeO₂ protective coating which prevented the appearance of firestain during brazing and flame annealing which results from the oxidation of copper at high temperatures. Furthermore the development of tarnish was appreciably delayed by the addition of germanium, the surface turned slightly yellow rather than black and tarnish products were easily removed by ordinary tap water. The alloy was said to be useful inter alia in jewelry. However, the alloy disclosed in the above patent suffers limitations insofar as it can exhibit large grain size, leading to poor deformation properties and formation of large pools from low-melting eutectics resulting in localised surface melting when the alloy is subject to the heat of an air torch.

Patents U.S. Pat. No. 6,168,071 and EP-B-0729398 (Johns) disclose a silver/germanium alloy which comprised a silver content of at least 77 wt % and a germanium content of between 0.4 and 7%, the remainder principally being copper apart from any impurities, which alloy contains elemental boron as a grain refiner at a concentration of more than 0 ppm and less than 20 ppm. The boron content of the alloy can be achieved by providing the boron in a master copper/boron alloy having 2 wt % elemental boron. It was reported that such low concentrations of boron surprisingly provide excellent grain refining in a silver/germanium alloy, imparting greater strength and ductility to the alloy compared with a silver/germanium alloy without boron. The boron in the alloy inhibits grain growth even at temperatures used in the jewelry trade for soldering, and samples of the alloy were reported to have resisted pitting even upon heating repeatedly to temperatures where in conventional alloys the copper/germanium eutectic in the alloy would melt. Strong and aesthetically pleasing joints between separate elements of the alloy can be obtained without using a filler material between the free surfaces of the two elements and a butt or lap joint can be formed by a diffusion process or resistance or laser welding techniques. Compared to a weld in Sterling silver, a weld in the above-described alloy has a much smaller average grain size that improved the formability and ductility of the welds, and an 830 alloy has been welded by plasma welding and polished without the need for grinding.

Ternary and quaternary alloys e.g. Ag—Cu—Ge alloys and Ag—Cu—Zn—Ge alloys include two base metal alloying elements, Cu and Ge, in a noble parent metal, Ag. On exposure to an oxidising atmosphere, two oxidation reactions have to be considered. Firstly, the oxidation of copper to cuprous oxide:
4[Cu]_{alloy}0₂(g)→2Cu₂0(s) (1)
Secondly, the oxidation of germanium to germanium (di)oxide:
[Ge]_{alloy}+0₂(g)→GeO₂(s) (2)
The above equation shows formation of germanium (IV) oxide, GeO₂, but there may also be formed germanium (II) oxide, GeO or an intermediate material GeₓO_{y} where x is 1 and y is greater than 1 but less than 2. Under standard conditions, i.e. for pure Cu and pure Ge each reacting with pure oxygen gas at 1 atm pressure to form the pure oxide phase, both reactions are feasible, with the chemical driving force for reaction (2) being higher than that of reaction (1) by a factor of 1.65.

According to WO 02/095082 (Johns) tarnish resistance of ternary alloys of silver, copper and germanium or quaternary alloys of silver, copper, zinc and germanium can be increased by casting a molten mixture to form the alloy and annealing the alloy to re-crystallize the grains in the alloy, the annealing being carried out under a selectively oxidizing atmosphere e.g H₂/H₂O or CO/CO₂ to promote the formation of GeO₂ while preventing the formation of Cu₂O.

Silver alloys according to the teaching of EP-B-0729398, U.S. Pat. No. 6,168,071 are commercially available under the trade name Argentium™ Silver and the word “Argentium” as used herein refers to these alloys. Although Argentium™ Silver exhibits improved tarnish resistance compared to eg. regular sterling silver, and any discolouration that may form can easily be removed, there is still room for improvement in tarnish resistance.

Treatment Compositions for Removing or Preventing Silver Tarnish

Various proposals have been made for cleaning or protecting Sterling silver and other known grades of silver to remove tarnish and/or to inhibit the formation of tarnish.

U.S. Pat. No. 2,841,501 discloses a silver polish based on an abrasive powder and a C₁₂-C₂₀ n-alkane thiol which is said to be non-toxic, to have a mild odor and to protect silver against tarnishing by forming a monomolecular layer R—S—Ag wherein R represents the alkane chain of the thiol, said layer forming a physical barrier between the silver and reactive ingredients of the atmosphere.

GB-A-1130540 is concerned with the protection of a finished surface of Sterling or Britannia silver as a step in a production run, and discloses a process that comprises the steps of:

wetting a clean silver surface of an article with a solution comprising 99 parts by weight of a volatile organic solvent, for example trichloroethylene or 1,1,1-trichloroethane and from 0.1-1.8 parts by weight of an organic solute containing a —SH group and capable of forming a transparent colourless protective layer on the silver surface, for example stearyl and cetyl mercaptan or thioglycollate;

allowing the solution to react with the surface to form such a layer and allowing the solvent to evaporate; and

washing the surface with a detergent solution, rinsing the surface with hot water and allowing it to dry. The above process is stated to provide a “long-term finish” intended to last the intended shelf-life until the article reaches the user. Halohydrocarbons were said to be the most suitable solvents but their suitability on environmental grounds is now open to question. Ethers were said to be flammable and toxic, and lower alcohols were said to be poor solvents. Water is not mentioned as a solvent. Applicants have seen a report on the Internet from ATOFINA Chemicals Inc that the solubility of mercaptans in water decreases progressively from 23.30 g/litre for methyl mercaptan to 0.00115 g/litre for nonyl mercaptan, and data for for both hexadecyl and octadecyl mercaptan (CAS 2885-00-9) reports them as water- insoluble.

U.S. Pat. No. 6,183,815 (Enick) also teaches that treatments of the above kind are result in the formation of a self-assembled coating derived from the thiol compounds in which the sulphur atoms are bound onto the metal surface and the alkyl tails are directed away from the metal surface. In the examples of that specification, fluoroalkyl amides e.g. CF₃(CF₂)₅CONH(CH₂)₂SH in aqueous alcohols e.g. aqueous isopropanol are sprayed onto the surface of silver, after which the surface is rinsed and dried with a soft cloth. The fluoroalkyl amides lack detectable odour and can dissolve in lower alcohols or alcohol/water mixtures, although it is apparent from the description and examples that not all alcoholic solvents produce good films.

Yousong Kim et al report that the adsorption of thiols onto silver proceeds through an anodic oxidation reaction that produces a shift of the open circuit potential of the substrate metal in the negative direction or if the potential is fixed an anodic current peak:
RSH+M(0)→RS—M(I)+H⁺+e⁻(M) (M=Au or Ag), see
http/www.electrochem.org/meetings/past/200/abstracts/symposia/h1/1026.pdf

Kwan Kim, Adsorption and Reaction of Thiols and Sulfides on Noble Metals, Raman SRS-2000, 14-17 Aug. 2000, Xaimen, Fujian, China, http://pcoss.org/icorsxm/paper/kuankim.pdf, also discloses the formation of self-assembled monolayers and discloses that alkanethiols, dialkyl sulfides and dialkyl disulfides self-assemble on silver surfaces with aliphatic dithiols forming dithoiolates by forming two Ag—S bonds.

In contrast, the literature on formation of alkylthiols of germanium is relatively sparse. The dissociative adsorption of H₂S at a Ge 100 surface to yield adsorbed —SH groups and adsorbed hydrides has been reported by Nelen et al., Applied Surface Science, 150, 65-72 (1999), see http://www.chem.missouri.edu/Greenlief/pubs/00005797.pdf, see also a report by Professor Michael Greenlief of the University of Missouri-Columbia http://www.chem.missouri.edu/Greenlief/Research.html that room temperature exposure of H₂S to Ge(100) results in dissociative adsorption that can be followed easily by ultraviolet photoelectron spectroscopy. The reaction of alkanethiols with Ge to form a high quality monolayer has been reported in the context of semiconductor and nanotechnology by Han et al, J. Am. Chem. Soc., 123, 2422 (2001). In the experiment described, a Ge(111) wafer is sonicated in acetone to dissolve organic contaminants and immersed in concentrated HF to remove residual oxide and produce a hydrogen-terminated surface, after which the wafer is immersed in an alkanethiol solution in isopropanol, sonicated in propanol and dried.

### SUMMARY OF THE INVENTION

The applicants have unexpectedly discovered that the treatment agents can be dissolved or dispersed directly in aqueous surfactant without the need for preliminary dissolving of the treatment agent in an organic solvent and subsequent mixing of the resulting solution with aqueous liquid. The resulting solutions are useful for the treatment of Argentium silver, but may find use as treatment solutions or polishes for conventional Sterling silver and other metals subject to surface deterioration e.g. copper, brass and nickel. Embodiments of the above compositions are optically clear and storage-stable at ambient temperatures for a period of weeks or months.

In a further aspect, therefore, the invention comprises a water-based composition for treating a metal, comprising a treatment agent selected from an alkanethiol, alkyl thioglycollate, dialkyl sulfide or dialkyl disulfide and at least one of an amphoteric, nonionic or cationic surfactant in a concentration that is effective to solubilise the treatment agent.

In a yet further aspect, the invention provides a method for manufacturing a water-based composition as aforesaid which comprises directly dissolving or dispersing the treatment agent in water containing the amphoteric, nonionic or cationic surfactant in a concentration that is effective to solubilise the treatment agent, and optionally further diluting the resulting solution or dispersion.

In a yet further aspect the invention provides a method for manufacturing a water-based composition comprising a treatment agent selected from an alkanethiol, alkyl thioglycollate, dialkyl sulfide or dialkyl disulfide and at least one of an amphoteric, nonionic or cationic surfactant, which method comprises:

mixing the treatment agent with at least one surfactant which is a non-ionic relatively hydrophobic surfactant and with an anionic and a zwitterionic surface active agent which may be present at the time of mixing or may be added subsequently, the surface active agents being at concentrations effective to solubilise the treatment agent, and

optionally further diluting with water the resulting solution or dispersion.

### DETAILED DESCRIPTION OF THE INVENTION

Silver-Copper-Germanium Alloys

The alloys that may be treated according to the invention include standard Sterling silver and an alloy of silver containing an amount of germanium that is effective to reduce firestain and/or tarnishing.

The ternary Ag—Cu—Ge alloys and quaternary Ag—Cu—Zn—Ge alloys that can suitably be treated by the method of the present invention are those having a silver content of at least 30%, preferably at least 60%, more preferably at least 80%, and most preferably at least 92.5%, by weight of the alloy, up to a maximum of no more than 98%, preferably no more than 97%.

The germanium content of the Ag—Cu—(Zn)—Ge alloys should be at least 0.1%, preferably at least 0.5%, more preferably at least 1.1%, and most preferably at least 1.5%, by weight of the alloy, up to a maximum of preferably no more than 6.5%, more preferably no more than 4%.

If desired, the germanium content may be substituted, in part, by one or more elements which have an oxidation potential selected from Al, Ba, Be, Cd, Co, Cr, Er, Ga, In, Mg, Mn, Ni, Pb, Pd, Pt, Si, Sn, Ti, V, Y, Yb and Zr, provided the effect of germanium in terms of providing firestain and tarnish resistance is not unduly adversely affected. The weight ratio of germanium to substitutable elements may range from 100:0 to 60:40, preferably from 100:0 to 80:20. Preferably, the germanium content consist entirely of germanium, i. e. the weight ratio is 100:0.

The remainder of the ternary Ag—Cu—Ge alloys, apart from impurities and any grain refiner, will be constituted by copper, which should be present in an amount of at least 0.5%, preferably at least 1%, more preferably at least 2%, and most preferably at least 4%, by weight of the alloy. For an ‘800 grade’ ternary alloy, for example, a copper content of 18.5% is suitable. The remainder of the quaternary Ag—Cu—Zn—Ge alloys, apart from impurities and any grain refiner, will be constituted by copper which should be present in an amount of at least 0.5%, preferably at least 1%, more preferably at least 2%, and most preferably at least 4%, by weight of the alloy, and zinc which should be present in a ratio, by weight, to the copper of no more than 1:1. Therefore, zinc is optionally present in the silver-copper alloys in an amount of from 0 to 100 % by weight of the copper content. For an ‘800 grade’ quaternary alloy, for example, a copper content of 10.5% and zinc content of 8% is suitable.

In addition to silver, copper and germanium, and optionally zinc, the alloys preferably contain a grain refiner to inhibit grain growth during processing of the alloy. Suitable grain refiners include boron, iridium, iron and nickel, with boron being particularly preferred. The grain refiner, preferably boron, may be present in the Ag—Cu—(Zn)—Ge alloys in the range from 1 ppm to 100 ppm, typically from 2 ppm to 50 ppm, more typically from 4 ppm to 20 ppm, by weight of the alloy.

In a preferred embodiment, the alloy is a ternary alloy consisting, apart from impurities and any grain refiner, of 80% to 96% silver, 0.1 % to 5% germanium and 1% to 19.9% copper, by weight of the alloy. In a more preferred embodiment, the alloy is a ternary alloy consisting, apart from impurities and grain refiner, of 92.5% to 98% silver, 0.3% to 3% germanium and 1% to 7.2% copper, by weight of the alloy, together with 1 ppm to 40 ppm boron as grain refiner. In a further preferred embodiment, the alloy is a ternary alloy consisting, apart from impurities and grain refiner, of 92.5% to 96% silver, 0.5% to 2% germanium, and 1% to 7% copper, by weight of the alloy, together with 1 ppm to 40 ppm boron as grain refiner

Further alloys that can be treated according to the invention are those disclosed in U.S. Pat. No. 6,726,877 (Eccles) which discloses a fire scale resistant, work hardenable jewellery silver alloy composition comprising: at least 86 wt % silver; 0.5-7.5 wt % copper 0.07-6 wt % of a mixture of zinc and silicon in which silicon is present in an amount of from about 0.02 to about 2.0 wt %; and from about 0.01 to no more than 2.0 wt % germanium. One of the disclosed alloys comprises 92.5 wt % silver, 3.14 wt % zinc, 3.0 wt % copper, 1.0 wt % germanium, 0.2 wt % indium, 0.15 wt % silicon and 0.01 wt % boron. Because of the germanium content, the protective effect of the present compositions is expected to be similar to that experienced with Argentium.

Yet further alloys that can be treated according to the invention and that may benefit because of their germanium content are disclosed in U.S. Pat. No. 6,406,664 (Diamond). Amounts of germanium as low as 0.1wt % can be effective provided that substantial amounts of tin are present but although formulation examples are given, no test data for corrosion or firestain is given either for articles made by casting or for articles fabricated from sheet. The inventor considers that 0.5 wt % Ge provides a preferred and more realistic lower limit and that in practice use of less than 1 wt % is undesirable. A two-component copper-free alloy could comprise 99% Ag and 1% Ge, and a tarnish-free casting alloy for jewellery has been reported that comprises 2.5% Pt, 1% Ge, balance Ag and optionally containing Zn, Si or Sn.

A further germanium-containing alloy that may advantageously be treated with the present compositions includes that sold under the trade name Steralite B which is believed to contain approximately 92.63 wt % silver, 5.17 wt % copper, 0.87 wt % zinc. 0.77 wt % tin, 0.4 wt % silicon and 0.4 wt % germanium.

Other alloys that may be polished with the compositions of the invention include those described in U.S. Pat. No. 3,811,876 (Harigawa), U.S. Pat. No. 4,973,446 (Bernhard, United Precious Metals; covers material sold under the trade name Steralite A) and U.S. Pat. No. 6,406,664 (Diamond).

Protective Agents

As protective agent there may be used a compound containing a long chain alkyl group and a —SH or —S—S— group, e.g. an alkanethiol, dialkyl sulfide or dialkyl disulfides in which the chain is preferably at least 10 carbon atoms long and may be C₁₂-C₂₄. The —SH or —S—S— compounds that many be used include straight chain saturated aliphatic compounds containing 16-24 carbon atoms in the chain, for example cetyl mercaptan (hexadecyl mercaptan) and stearyl mercaptan (octadecyl mercaptan) and cetyl and stearyl thioglycollates whose formulae appear below.

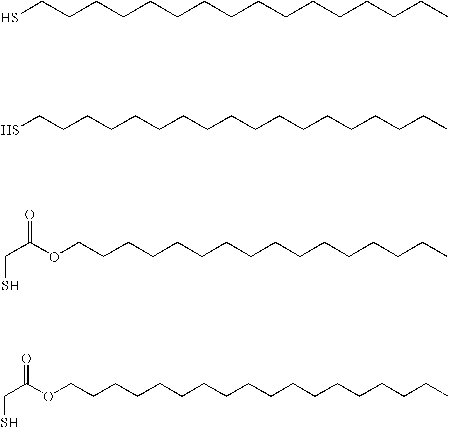

Octadecyl mercaptan is a white to pale yellow waxy solid that is insoluble in water and that melts at 30° C. Hexadecyl mercaptan is also a white or pale yellow waxy solid that melts at 17° C.

The treatment agents may comprise, in a final diluted composition, 0.1-5 wt %, more preferably 0.5-2 wt % and most preferably about 1 wt %.

Formulations Based on Aqueous Liquids

It has surprisingly been found that formulations containing effective amounts of the treatment agents can be made by dissolving them directly in aqueous liquids containing an amphoteric, nonionic or cationic surfactant band free from water-immiscible organic solvents and preferably free from all other solvents. The treatment agents may be dissolved in relatively concentrated surfactant-containing aqueous liquids,which may be used as such or after subsequent dilution with water.

A further aspect of the invention therefore provides a water-based composition for treating a metal, comprising a treatment agent selected from an alkanethiol, alkyl thioglycollate, dialkyl sulfide or dialkyl disulfide and at least one of an amphoteric, nonionic or cationic surfactant in a concentration that is effective to solubilise the treatment agent.

In particular, it has surprisingly been found that the treatment agents may be dissolved in a non-ionic relatively hydrophobic surfactant either alone or in admixture with a polyol e.g. glycerol, and that the resulting mixture can be rendered water-dispersible by mixture with ionic hydrophilic surfactants. One class of non-ionic relatively hydrophobic surfactants comprises a single C₁₀-C₂₄ alkyl or alkenyl, preferably a C₁₂-C₁₈ alkyl or alkenyl hydorphobic moiety and a single polar non-ionic headgroup.

A preferred class of non-ionic relatively hydrophobic surfactants is provided by compounds of the formula
R₁CONHₘ(CH₂CH₂OH)ₙ
wherein R₁ represents C₁₀-C₂₄ alkyl or alkenyl and is preferably C₁₂-C₁₈, m is 0 or 1 and n is 1 or 2. Compounds of this type include capramide MEA, capramide DEA, lauramide MEA, lauramide DEA, myristamide MEA, myristamide DEA, palmamide MEA, palmamide DEA, stearamide MEA, stearamide DEA, oleamide MEA, oleamide DEA, linoleamide MEA, linoleamide DEA, arachidamide MEA, arachidamide DEA, cocamide MEA and cocamide DEA, the latter compound being preferred.

A further class of relatively hydrophobic solvents is provided by ethoxylated fatty acid monoglycerides e.g. of the formula: 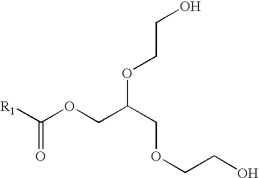
wherein R₁ represents C₁₀-C₂₄ alkyl or alkenyl and is preferably C₁₂-C₁₈. A preferred compound of this class is glycereth-2-cocoate.

Other semi-polar nonionic surface active agents comprising a single C₁₀-C₂₄ alkyl or alkenyl, preferably a C₁₂-C₁₈ alkyl or alkenyl hydorphobic moiety and a single polar non-ionic headgroup may also be used, including amine oxides, phosphine oxides, and sulfoxides. Suitable classes of compound include:
Sulfoxide surfactants, for example dodecyl methyl sulfoxide, tetradecyl methyl sulfoxide, octadecyl methyl sulfoxide, 3-hydroxytridecyl methyl sulfoxide, 3-methoxytridecyl methyl sulfoxide, 3-hydroxy-4-dodecoxybutyl methyl sulfoxide, octadecyl 2-hydroxyethyl sulfoxide, and dodecylethyl sulfoxide.
Phosphine oxide surfactants, e.g. dimethyldodecylphosphine oxide, dimethyltetradecylphosphine oxide, ethylmethyltetradecylphosphine oxide, cetyldimethylphosphine oxide, dimethylstearylphosphine oxide, cetylethylpropylphosphine oxide, diethyldodecylphosphine oxide, diethyltetradecylphosphine oxide, dipropyldodecylphosphine oxide, dipropyldodecylphosphine oxide, bis-(hydroxymethyl)dodecylphosphine oxide, bis-(2-hydroxyethyl)dodecylphosphine oxide, (2-hydroxypropyl)methytetradecylphosphine oxide, dimethyloleylphosphine oxide, and dimethyl-(2-hydroxydodecyl)phosphine oxide and the corresponding decyl, hexadecyl, and octadecyl homologs of the above compounds.
Amine oxide surfactants, for example dimethyldodecylamine oxide, dimethyltetradecylamine oxide, ethylmethyltetradecylamine oxide, cetyldimethylamine oxide, dimethylstearylamine oxide, cetylethylpropylamine oxide, diethyldodecylamine oxide, diethyltetradecylamine oxide, dipropyldodecylamine oxide, bis-(2-hydroxyethyl)dodecylamine oxide, bis-(2-hydroxyethyl)-3-dodecoxy-2-hydroxypropylamine oxide, (2-hydroxypropyl)methyltetradecylamine oxide, dimethyloleylamine oxide, dimethyl-(2-hydroxydodecyl)amine oxide, and the corresponding decyl, hexadecyl and octadecyl homologs of the above compounds.

Other non-ionic surface-active agents that may be used alone or in admixture include compounds produced by the condensation of an alkylene oxide with an organic hydrophobic compound that may be aliphatic or alkyl aromatic. The length of the hydrophilic or polyoxyalkylene moiety that is condensed with any particular hydrophobic compound can be adjusted to yield a water-soluble compound having the desired balance between hydrophilic and hydrophobic moieties. Compounds of this class include:
Polyethylene oxide condensates of alkyl phenols. These compounds include the condensation products of alkyl phenols having an alkyl group containing from about 6 to 12 carbon atoms in either a straight or branched chain, with ethylene oxide, the said ethylene oxide being present in amounts equal to 5 to 25 moles of ethylene oxide per mole of alkyl phenol. The alkyl substituent in such compounds may be derived, for example, from polymerized propylene, diisobutylene, octene, or nonene.
Condensation products of aliphatic alcohols with ethylene oxide. The alkyl chain of the aliphatic alcohol may either be straight or branched and generally contains from about 8 to about 22 carbon atoms.
Condensation products of ethylene oxide with the product resulting from the reaction of propylene oxide and ethylene diamine.

The non-ionic surfactant may be present in the final diluted composition in an amount of 0.5-10 wt %, more preferably 1-6 wt % and most preferably 2-5 wt %.

Where a polyol such as glycerin is incorporated, it is preferably present in the final diluted composition in an amount of 0.5-10 wt %, preferably 1-8 wt % and most preferably 1-5 wt %.

After the treatment agent has been dissolved in the non-ionic surface-active agent and the polyol, if present, there may then be added ionic surfactants for improving water-dispersibility and these may be anionic, amphoteric or less preferably cationic. Mixtures of anionic and amphoteric surfactants, in particular, have been found to be effective. If desired non-ionic, anionic surfactants and zwitterionic surfactants may be mixed together before addition of the treatment agent, but in either case the mixing should best take place before dilution to the final composition, otherwise the full protective effects of the present composition may not be achieved.

A wide variety of alkyl sulfates may be used as anionic surface-active agents including fatty alcohol sulphates, fatty alcohol ether sulphates, alkyl phenol ether sulphates, alkyl aryl sulphonic acids and salts thereof, cumene, toluene and xylene sulphonates and salts thereof and alkyl sulphosuccinates e.g. sodium or ammonium lauryl sulfate. However, a preferred class of anionic surface active agents is polyol monoalkylether sulfates of the formula RO—(CH₂CH₂)ₙSO₃M wherein R represents C₁₀-C₁₈ alkyl, n is 2-6 (preferably about 2-3) and M represents a monovalent cation. Such compounds are sulfonated ethoxylated C₁₀-C₁₈ alcohols which may be derived from coconut oil or tallow or may be synthetic. Sodium laureth sulfate which has been used successfully herein is a sodium lauryl ether sulphate ethoxylated to an average of two moles of ethylene oxide per mole of lauric acid and sulfated, and is of formula CH₃(CH₂)₁₀CH₂(OCH₂CH₂)₂OSO₃Na.

In the final diluted composition the amount of anionic surfactant (solids) is preferably 0.1-15 wt %, more preferably 0.3-10 wt % and most preferably 0.5-1 wt %. Although relatively high concentrations of the anionic surfactant have been found to work well, as in the Simple shower gel, it has been found in practice that significantly lower concentrations can still give acceptable results, and on grounds of economy there is no advantage in using more of the anionic surfactant than is needed.

Amphoteric or zwitterionic surfactants that may be used alone or in admixture with one another and/or with nonionic surfactants and/or with anionic surfactants may be derivatives of secondary or tertiary amines, derivatives of heterocyclic secondary and tertiary amines, or derivatives of quaternary ammonium, quaternary phosphonium or tertiary sulfonium compounds. The cationic atom in the quaternary compound can be part of a heterocyclic ring. In all of these compounds there is at least one aliphatic group, straight chain or branched, containing from about 3 to 18 carbon atoms and at least one aliphatic substituent containing an anionic water-solubilizing group, e.g., carboxy, sulfonate, sulfate, phosphate, or phosphonate.

Examples of zwitterionic surfactants that may be employed include betaine surfactants, which are preferred, imidazoline-based surfactants, aminoalkanoate surfactants and iminodialkanoate surfactants. Suitable such surfactants include amidocarboxybetaines, such as cocoarnidodimethylcarboxymethylbetaine, laurylamidodimethylcarboxymethyl-betaine, cetylamidodimethylcarboxymethyl-betaine, and cocoamido-bis-(2-hydroxyethyl)carboxymethyl-betaine. Particularly preferred are amidocarboxybetaines betaines of the formula below wherein R represents C₈-C₁₈ alkyl e.g. cocamidopropyl betaine. That compound is generally regarded as safe: in an Ames test conducted by BASF it did not prove mutagenic to Salmonella indicator organisms and in a human repeated patch insult test (IPT) it did not indicate either contact hypersensitivity or photoallergy (see the MAFO CAB cocamidopropyl amino betaine data sheet published by BASF): 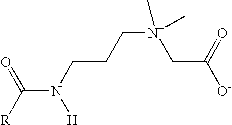
Also useful are sulphobetaine surfactants, e.g amido sulfobetaines such as lauramido-sulfopropylbetaine of formula indicated below, 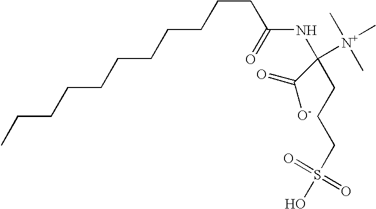
cocamido-2-hydroxypropylsulfobetaine, cocoarnidodimethylsulfopropyl-betaine, stearylamido-dimethylsulfopropylbetaine, and laurylamido-bis-(2-hydroxyethyl)-sulfopropylbetaine. Also useful may be imidazoline-based surfactants including gylcinate and amphoacetate compounds e.g. cocoamphocarboxypropionate, cocoamphocarboxypropionic acid, cocoamphocarboxyglycinate, and cocoamphoacetate, aminoalkanoate surfactants e.g. n-alkylamino-propionates and n-alkyliminodipropionates such as N-lauryl-β-amino propionic acid and salts thereof, and N-lauryl-β-imino-dipropionic acid and salts thereof.

In the final diluted composition, the zwitterionic surfactant may for example by up to 15 wt %, typically 0.3-6 wt %, preferably 0.6-3 wt % and most preferably 0.9-1.5 wt %.

Cationic surfactants include quaternary ammonium compounds having one or two hydrophobic chains attached to the nitrogen atom and pyridinium compounds with a hydrophobic chain attached to nitrogen, the hydrophobic chain being e.g. up to C₄₀ alkyl, alkaryl or aralkyl, preferably about C₁₂-C₁₈, as in the cations below: 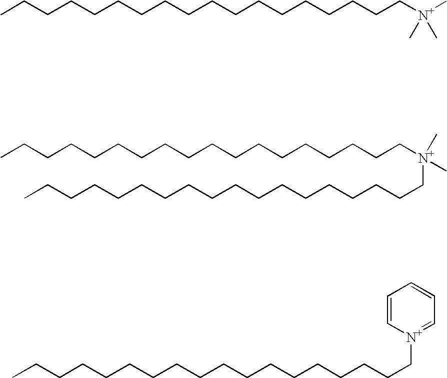
Representative compounds of the above types include alkylbenzyldimethyl ammonium chloride, coconut alkylamine acetate, lauryl, cetyl or stearyl trimethyl ammonium chloride di-stearyl-dimethyl ammonium chloride, di-hydrogenated tallow dimethyl ammonium chloride (DHTDMAC), N-dodecyl pyridinium chloride and cetylpyridinium chloride. There may also be used polyethoxylated quaternary ammonium salts e.g. of formula 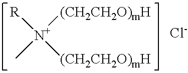
wherein R represents C₁₀-C₄₀, esp C₁₂-C₁₈ alkyl e.g. oleyl- or coco-. Further surfactants may be based on diethylene triamine (DETA)-based quaternaries, such as diamidoamine ethoxylates and imidazolines, and esterquats. As a class, esterquats can be based on compounds including methyl diethanolamine (MDEA), triethanolamine (TEA), and N,N-dimethyl-3aminopropane-1,2-diol (DMAPD).

The composition also advantageously contains a salt of a strong alkali with a strong mineral acid e.g. sodium chloride or sodium sulfate. The salt may be added before or after final dilution, but for best tarnish protection of both standard Sterling and of Argentium silver (contains Ge), the salt is added prior to dilution. The amount of salt in the final diluted composition is typically 0.1-3 wt %, preferably 0.5-2 wt % and most preferably about 1 wt %. Salts of monovalent cations with monovalent or divalent cations may be used individually or together: for example the composition may contain a mixture of sodium chloride and sodium sulphate. For example, a mixture may combine the tarnish-resistant properties imparted by the sodium chloride with the dispersibility and clarity imparted by the sodium sulfate.

Either before or after the dilution step, the pH of the solution may be adjusted using citric acid or another weak organic acid to 4-8, preferably 6-7.

The treatment agent may be present in said composition, prior to dilution thereof, in an amount of at least 0.1 wt % and preferably at least 1 wt %, the solids content of the composition being at least 5 wt %, typically 10-40 wt % and possibly 50 wt % or more. The ability of aqueous surfactant liquids to dissolve or disperse such relatively high concentrations of higher alkyl thiols and other treatment agents which are reported to be highly water-insoluble has not been described. The resulting concentrates may be diluted with water to provide an aqueous treatment dip or combined degreasing solution and dip for use as explained above, and it has been found that the treatment agent may remain in solution or suspension following such dilution and may remain effective for the surface treatment of silver-copper or silver-copper-germanium alloys and possibly other metals such as copper, brass and nickel where surface protection films may retard corrosion. Particularly good results from the stability and effectiveness standpoint may be obtained by mixing hexadecyl mercaptan (in the liquid state) straight into a surfactant “carrier” and using the solution as such or on subsequent dilution with water.

In particular, the present treatment agents can be successfully dispersed in aqueous liquids containing mixtures of neutral and anionic surfactants with the neutral surfactants providing e.g. about 25-50% e.g. 33 wt % of the total surfactant present. Treatment agents that can be dispersed in such agents include n-hexadecyl thiol and n-octadecyl thiol. They can also be successfully dispersed in aqueous liquids containing mixtures of amphoteric or zwiterionic surfactants and anionic surfactants and such mixtures can provide relatively storage stable optically clear solutions with little or no tendency to re-precipitate the treatment agent. In that case the weight ratio of the amphoteric or zwitterionic surfactant to the anionic surfactant may be from 1:1.5 to 1.5:1, typically close to 1:1.

In addition to simple treatment agents, the above compositions may be formulated into metal polishes e.g. for silver or brass. Such products may be formulated as liquid products into which objects such as jewelry or cutlery are to be dipped. After dipping, the objects are usually rinsed under water and dried with a soft cloth. Alternative formulations take the form of creams or pastes, which are applied with a soft cloth and then removed.

For formulation into dipping compositions, the active ingredients are normally an acid having a pKa of not more than 5, e.g. phosphoric, citric, oxalic, or tartaric acid together with thiourea or a derivative thereof e.g. an alkyl derivative such as methyl or ethyl thiourea. For formulation into creams or pastes there may be e.g. about 25 wt % of a mild abrasive such as precipitated chalk, infusorial earth, silica or γ-alumina (e.g. 0.05 μm grade). These ingredients are believed compatible with the surfactants and treatment agents and can be incorporated when convenient by simple mixing.

The compositions of the invention may also be used to impregnate wipes or polishing cloths of soft woven, knitted or non-woven textile material e.g. a soft cotton cloth, which may be stored in a water-impervious container (e.g. a foil wrap) in a moist state or may be dried.

Treatment Procedures

The surface treatment may be carried out after the manufacturing stages for a shaped article made of the alloy have been completed. The article may be of flatware, hollowware or jewelry. Fabrication steps may include spinning, pressing, forging, casting, chasing, hammering from sheet, planishing, joining by soldering brazing or welding, annealing and polishing using buffs/mops and polishing compounds e.g. aluminium oxide or rouge.

An article to be treated may be de-greased by various methods:
Vapour degreasing with or without ultrasonics
Aqueous degreasing with or without ultrasonics
Organic solvent degreasing with or without ultrasonics (e.g. degreasing with ethanol or acetone prior to thiol treatment which may provide very good accelerated tarnish test results).
Simultaneous degreasing and thiol treatment, the thiol being present in an organic or aqueous degreasing medium.

For example, the article may be degreased ultrasonically in a treatment bath, dipped into a bath containing a water-based hexadecyl mercaptan treatment composition (e.g. 100 g Simple Shower Gel/1 g hexadecyl mercaptan), rinsed in one or more baths containing the surfactant but not the thiol and allowed to dry by evaporation. Rinsing excess thiol away with water/surfactant solution may then be carried out, so that thiols that have not reacted with the metallic surface are removed and are unavailable to react with anything else. If necessary the article can then be rinsed in water. The mercaptan treatment application gives articles good hydrophobic properties, which assists rinsing and drying processes. The article may then be packed for delivery into the distribution chain. This may include wrapping the article in one or more protective sheets, placing it in a presentation box, and wrapping the presentation box in a protective wrapping e.g. of heat-shrunk plastics film. Articles which have been treated with an organic compound containing —SH or —S—S— groups as aforesaid and packaged should not only reach their point of sale in good condition but should if displayed e.g. on a shelf or in a cabinet for an extended period, expected to be at least 6 months and possibly 12 months or more, remain without development of significant tarnish.

The invention will now be further described, by way of illustration only, with reference to the following examples. Throughout the examples, the term “enhanced tarnish resistance” of samples treated with octadecyl or hexadecyl mercaptan refers to the comparison with samples of Argentium Silver which have not had any treatment except for polishing and degreasing.

The following Ammonium Polysulphide accelerated tarnish test procedure was used for all accelerated tarnish testing mentioned in the following examples:—Approximately 40 ml Ammonium Polysulphide solution—assay (as (NH₄)₂S from sulphide) about 20%, was poured into a dish (inside dimensions: width=8 cm, depth=6 cm, height=3 cm)—giving approximately 1 cm height of solution in the dish. A glass strip (width=11.5 cm, depth=2.5 cm, height=0.2 cm) was placed on top of the dish, over the solution and samples to be tested were then place on top of the glass strip for the times stated in the examples. The test was carried out inside a fume cabinet.

### EXAMPLE 1

### Hexadecyl Mercaptan in Fairy Liquid

Hexadecyl mercaptan (1 g) in the liquid state was mixed with Fairy liquid (surfactant containing anionic and nonionic surface active agents) and with water in the quantities indicated below:

| Reference | Fairy liquid (ml) | Deionised water (ml) |
|---|---|---|
| 1.1 | 40 | Nil |
| 1.2 | 100 | Nil |
| 1.3 | 200 | Nil |
| 1.4 | 40 | 100 |
| 1.5 | 40 | 200 |

The ingredients of solution 1.2 appeared to mix well without needing the hexadecyl mercaptan to be dissolved in an organic solvent beforehand. A sample of Argentium silver was immersed in the resulting solution for 10 minutes and rinsed. The surface of the Argentium sample had become hydrophobic, suggesting the formation of a layer of hexadecyl mercaptan attached to the surface of the Argentium silver. It rinsed well in water without any noticeable deposit being left on the surface after rinsing.

A region of the sample was rubbed with cotton wool soaked in EnSolv 765 and then subjected to tarnish testing with neat ammonium polysulphide over a period of 45 minutes. EnSolv 765 is an extremely good solvent for octadecyl and hexadecyl mercaptans, which is the reason for using this solvent for the thiol “rub” tests—to test the strength of the thiol bonding with the surface of the metals. EnSolv 765 is an n-propyl bromide based solvent, designed to address a wide variety of precision cleaning requirements and manufactured by Enviro Tech International Inc., see U.S. Pat. Nos. 5,616,549, 5,824,162, 5,938,859 and 6,176,942. Excellent tarnish resistance was noted, without significant difference between the region that had been treated with EnSolv 765 and the region that had not been so treated. Similar solutions were prepared from octadecyl mercaptan and Fairy liquid. They were transparent at first, but of lesser stability with separation of a surface layer of octadecyl mercaptan after some months.

### EXAMPLE 2

### Hexadecyl Mercaptan in Simple Shower Gel

Simple shower gel, a clear shower gel, was obtained from Accentia Health and Beauty Ltd, Birmingham, UK It contains sodium laureth sulfate (10.0%), cocamidopropyl betaine (2.8%), coconut fatty acid diethanolamide (1.8%), sodium chloride (0.95%) and glycerin the balance being water. Analysis was by drying the shower gel on a steam-bath under a steady stream of nitrogen followed by vacuum oven treatment. The dried sample was dissolved in deuterated methanol and analysed by proton NMR. The proton NMR was compared with the spectra of known samples of sodium laureth sulfate, cocamidopropyl betaine and coconut fatty acid diethanolamide, and the ratio of these ingredients was estimated. The salt content of the gel was determined using a Corning chloride analyser 926 and sodium content was determined by atomic absorption spectroscopy.

The gel was mixed with liquid hexadecyl mercaptan and with water in the quantities indicated below:

| Reference | HDM (g) | Simple (ml) | Deionised water (ml) |
|---|---|---|---|
| 2.1 | 1 | 100 | Nil |
| 2.2 | 1 | 100 | 100 |
| 2.3 | 5 | 100 | 100 |
| 2.4 | 1 | 200 | 100 |

Some days after mixing, solutions 2.1 and 2.4 were completely transparent viscous gels free from noticeable separation of the hexadecyl mercaptan. Sample 2.2 was also completely transparent but had a water-like consistency and again did not exhibit separation of hexadecyl mercaptan. Sample 2.3 which also had a water-like consistency appeared as a milky emulsion when shaken but exhibited separation of hexadecyl mercaptan at the surface on standing.

In a preliminary experiment, a polished and degreased a sample of Argentium silver was immersed in solution 2.1 for 10 minutes and rinsed. The surface of the Argentium sample had become hydrophobic, suggesting the formation of a layer of hexadecyl mercaptan attached to the surface of the Argentium silver. It rinsed well in water and showed hydrophobic properties. When tested with neat ammonium polysulfide, excellent tarnish resistance was noted.

Samples of Argentium silver and conventional Sterling silver were prepared as follows. Each sample was polished with Steelbright polish, followed by rouge, and then ultrasonically degreased for two minutes in a 2 wt % Fairy liquid solution in water at 54° C. They were then further degreased for 5 minutes in ethanol and immersed at ambient temperatures in the test solution. After removal, part of each sample was rubbed with tissue soaked in EnSolv 765 and then subjected to tarnish testing with neat ammonium polysulphide over a period of 45 minutes. Argentium samples showed excellent tarnish resistance and thiol bonding, especially good results being obtained with solutions 2.1 and 2.4 compared to the higher water content solutions 2.2 and 2.3. Solutions 2.1 and 2.4 appeared to provide some tarnish protection for standard Sterling silver also, but the thiol layer could be removed easily as was apparent from the differences between the untreated and the EnSolv 765 treated regions.

### EXAMPLE 3

### Mixtures of Cocamidopropyl Betaine (CPB) and Sodium Laureth Sulfate (SLS)

The above materials were supplied as a thick pourable aqueous liquid and as a highly concentrated somewhat gelatinous liquid (70% active) by Surfachem Ltd of Leeds, United Kindgom. Hexadecyl mercaptan (1 ml) in the liquid state was mixed with these materials in the quantities indicated below:

| Reference | SLS (ml) | CPB (ml) | Water (ml) |
|---|---|---|---|
| 3.1 | 40 | 40 | 100 |
| 3.2 | 40 | 20 | 100 |
| 3.3 | 30 | 10 | 100 |
| 3.4 | 10 | 30 | 50 |
| 3.5 | 30 | 10 | 160 |

For solution 3.1, hexadecyl mercaptan was added to a thick mixture of sodium laureth sulphate and cocarnidopropyl betaine after which water was added and the solution was mixed cold. The resulting mixture initially had a thick foamy-white texture and on settling turned into a transparent gel. Solution 3.2 was somewhat similar. Solution 3.3 was watery and was initially slightly transparent with lots of bubbles on top of the solution, and on settling overnight it became transparent. Solution 3.4 was mixed with gentle heating to about 35° C. Heat appeared to slightly help with the mixing procedure. After a few minutes of mixing the mixture foamed severely. The mixture was allowed to stand overnight and formed a viscous solution. Solution 3.5 was heated to approximately 35° C. whilst mixing. Water was last ingredient to be added. Using heat for mixing proved beneficial. The solution appeared very foamy but this settled over a few hours (within 12 hours) to form a transparent solution slightly thicker than water.

Argentium silver samples were prepared by polishing in Steelbright and then rouge, ultrasonically degreasing in a 2% aqueous Fairy Liquid solution further degreasing in acetone, immersion in the test solution at ambient temperatures for 10 minutes, and washing under cold running tap water. A lower region of each sample was rubbed with tissue soaked in EnSolv in an attempt to attempt to remove any thiols, after which the samples was left to stand for 45 minutes and were then exposed to a neat ammonium polysuphide accelerated tarnishing test for 45 minutes.

All the samples showed extremely good hydrophobic properties during the rinsing process, which indicates presence of thiols. Water drops were repelled and there was no need to dry each sample. The samples performed well in the tarnishing test with resistance to tarnishing and little difference between the rubbed and un-rubbed regions. It was concluded that the hexadecyl mecaptan in each sample tested had created a tarnish-protective thiol-bonded layer on the surface of the Argentium silver. However, the solutions exhibited only moderate stability and tended to re-precipitate the mercaptan.

### EXAMPLE 4

The following treatment solution was mixed, with each ingredient being added in the order listed:—Cocamide DEA (>90%, 4 g), glycerin (1 g), sodium laureth sulphate (10% aqueous solution, 10 g), cocamidopropyl betaine (30% aqueous solution, 3 g), sodium chloride (1 g), Citric Acid (to achieve pH 6.5), purified water (10 g), hexadecyl mercaptan (1 g), purified water (70 g). The resulting solution settled to become transparent, a little more viscous than water and showed good stability, even at cold storage temperatures (unstable solutions show precipitates of hexadecyl mercaptan at temperatures below about 15° C.).

Degreased and polished samples of Argentium Sterling and standard Sterling were immersed in the above mentioned solution for 5 minutes and then rinsed under running tap water. A lower region of each sample was rubbed with cotton wool soaked in EnSolv 765 to attempt to remove any thiol on the surface, after which the samples were subjected to the above mentioned ammonium polysulphide accelerated tarnish test. The Argentium Sterling sample was removed from the test at 1 hour and exhibited no observable tarnish, (an untreated Argentium Sterling sample would exhibit some yellowing under the same conditions at 5 minutes exposure time). It was concluded that the thiol had become attached to the Argentium alloy and that said thiol could not be displaced by rubbing with EnSolv 765. The standard Sterling sample was observed at 10 minutes exposure time—the region that had not been rubbed with EnSolv 765 showed moderate tarnish, whereas the region that had been rubbed showed severe tarnish. It was concluded that the thiol had been deposited on the surface of the standard sterling alloy, which provided some protection against tarnish, but that the thiol was less securely attached than in the case of the Argentium Sterling sample. At one hour exposure time, the standard Sterling sample exhibited severe discolouration covering its whole surface.

### EXAMPLE 5

Hexadecyl mercaptan (1 g) in the liquid state was mixed with cocamide DEA (>90%, 4 g). This mixture was added to a mixture made up (in the order listed) of sodium laureth sulfate (10% aqueous solution, 10 g), cocamidopropyl betaine (30% aqueous solutions, 3 g), glycerin (5 g) and sodium chloride (1 g). The mixture was then diluted with purified water (76 g) and then neutralised to pH 6.5 with citric acid. The resulting solution settled over 24 hours to become transparent and displayed good stability to cold storage temperatures (as previously explained, unstable solutions show precipitates of hexadecyl mercaptan at temperatures below approximately 15° C.). Hexadecyl mercaptan mixed well with the cocamide DEA and remained in solution when added to the other ingredients (without the need for the hexadecyl mercaptan to be initially dissolved in an organic solvent).

In a repetition of the above procedure, sodium chloride was added after dilution with water and it was noticed that the solution was of reduced stability. It was concluded that it is better to add salt before dilution with water.

Polished and degreased samples of Argentium Sterling and standard sterling were immersed in the solution (prepared as described above) for 5 minutes and were rinsed under running tap water. The bottom sections of both treated samples were rubbed with cotton wool soaked in EnSolv 765 to test the strength of the thiol-bonding with each alloy. The silver samples were subjected to the above described ammonium polysulphide accelerated tarnish test for one hour. The Argentium Sterling sample was free of tarnish throughout the test and retained a very bright appearance, whereas the un-rubbed section of the standard sterling sample showed moderate discolouration within 10 minutes exposure, and severe discolouration at 1 hour. The Argentium Sterling sample displayed excellent thiol-bonding as the EnSolv 765 rubbed section looked no different to the un-rubbed section at one hour exposure. The EnSolv 765 rubbed section of the standard sterling sample started to tarnish severely as soon as the sample was placed in the tarnish test—this shows that the thiols could be easily removed from the surface of the alloy.

In a yet further repetition, the above solution was prepared without salt content. The resulting solution was very stable and optically transparent, but when samples of Argentium sterling and standard sterling were treated in the solution (5 minutes immersion time), rinsed under running tap water and then subjected to the above mentioned accelerated tarnish test, the samples gave disappointing test results. The Argentium sterling sample exhibited yellowing on exposure to ammonium polysulphide solution and the standard sterling sample quickly exhibited severe discolouration.

What is claimed is:

1-35. (canceled)

36. A water-based composition for treating a metal, comprising a treatment agent selected from an alkanethiol, alkyl thioglycollate, dialkyl sulfide or dialkyl disulfide, and in concentrations effective to solubilize said treatment agent:
a non-ionic relatively hydrophobic surfactant which is a compound of the formula
R₁CONHₘ(CH₂CH₂OH)ₙ
wherein R₁ represents C₁₀-C₂₄ alkyl or alkenyl, m is 0 or 1 and n is 1 or 2, or which is ethoxylated fatty acid monoglyceride; an anionic surfactant; and
a zwitterionic surfactant selected from betaine surfactants, imidazoline-based surfactants, aminoalkanoate surfactants and iminodialkanoate surfacts.

37. The composition of claim 36, wherein the treatment agent is hexadecyl or octadecyl mercaptan.

38. The composition of claim 36, comprising 0.5-10 wt %, preferably 1-6 wt % and most preferably 2-5 wt % of a non-ionic relatively hydrophobic surfactant which comprises:
(a) cocamide DEA;
(b) an ethoxylated fatty acid monoglyceride of the formula: 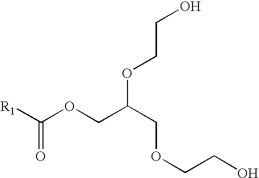
wherein R₁ represents C₁₀-C₂₄ alkyl or alkenyl, preferably C₁₂-C₁₈ alkyl or alkenyl; or
(c) glycereth-2-cocoate.

39. The composition of claim 36, further comprising 0.5-10 wt %, preferably 1-8 wt %, and more preferably 1-5 wt % of glycerol or of another polyol.

40. The composition of claim 36, comprising 0.1-15 wt %, preferably 0.3-10 wt %, more preferably 0.5-1 wt % of a monovalent cation salt of sodium laureth sulphate or another an anionic surfactant of the formula RO—(CH₂CH₂)ₙSO₃M wherein R represents C₁₀-C₁₈ alkyl, n is 2-6 and M represents a monovalent cation.

41. The composition of claim 36, comprising 0.3-6 wt %, preferably 0.6-3 wt % and more preferably 0.9-1.5 wt % of cocamidopropyl betaine or of another zwitterionic surfactant.

42. The composition of claim 36, comprising treatment agent in an amount of 0.5-2 wt %, preferably about 1 wt %.

43. The composition of claim 36, further comprising 0.1-3 wt %, preferably 0.5-2 wt %, more preferably about 1 wt % of sodium chloride, sodium sulphate or another salt of a strong base with a strong mineral acid.

44. The composition of claim 36, which is
(a) a polishing dip and further comprises an acid and a thiourea; or
(b) a cream or paste polish further comprising a solid polishing medium which may be precipitated chalk, infusorial earth, silica or γ-alumina.

45. The composition of claim 36, for the treatment of a silver-copper alloy, a silver-copper-germanium alloy, copper, brass or nickel.
